(19) United States
(12) Patent Application Publication
(10) Pub. No.: US 2009/0217668 A1
(43) Pub. Date: Sep. 3, 2009

(54) DEVICE FOR INFLUENCING AN EXHAUST GAS FLOW

(76) Inventors: Helmut Venghaus, Ingolstadt (DE); Uwe Gnauert, Gottingen (DE); Daniel Kohlrautz, Duderstadt (DE); Michael Wolfgang Wenzel, Bovenden (DE); Hubertus Siebald, Rosdorf (DE)

Correspondence Address: PAMELA A. KACHUR, 950 W 450 S, BLDG. 4, COLUMBUS, IN, 47201, US

(21) Appl. No.: 12/299,136

(22) PCT Filed: Apr. 13, 2007
(86) PCT No.: PCT/EP07/03294

§ 371 Date: Apr. 21, 2009

(30) Foreign Application Priority Data
May 2, 2006 (EP) 06009061.0
Jul. 24, 2006 (DE) 10-2006-034-177.5

(51) Int. Cl. F01B 31/16; F16K 31/02; F01N 7/00

(52) U.S. Cl. 60/694; 251/129.01; 181/212

(57) ABSTRACT

A device for influencing an exhaust gas flow, in particular for controlling the sound emission in an exhaust branch of an engine, includes a closure member that is movably arranged in the exhaust gas flow. For example, the closure member comprises a flap driven by a motor to move the closure member in the exhaust gas flow. It is thus optionally possible to produce or influence pressure pulsations in the exhaust gas which lead to an audible sound emission. The device according to the invention provides for a so-called “sound design” of a combustion engine. The driving device (the drive motor and a force transmission member to the closure member) is equipped with an active cooling system.

### RELATED APPLICATIONS

This application is the U.S. National Phase of PCT/EP2007/003294, filed 13 Apr. 2007, which claimed priority to European Application 06 009 061.0, filed May 2, 2006, and German Application 10 2006 034 177.5 filed 24 Jul. 2006.

### TECHNICAL FIELD

The invention relates to a device for influencing an exhaust gas flow, in particular for controlling the sound emission in an exhaust branch of an engine. The device has a closure member movably arranged in the exhaust gas flow and a driving device for the closure member, which comprises a drive motor and a force transmission member to couple the drive motor to the closure member for drive. The closure member offers different flow resistances to the exhaust gas flow depending on its position in the exhaust gas flow.

### BACKGROUND OF THE INVENTION

To meet the legal requirements relating to the sound emission of a vehicle, components such as mufflers for example, are mounted in the exhaust branch. The expenditure for the design and testing of an entire exhaust system with regard to the increasing demands is enormous, as is the constructional expenditure (costs, construction volume, etc.). Additionally to the legal requirements concerning the sound emission, the so-called “sound design” is also important, in particular in sports cars and sedan cars.

It is already known to arrange a pivoted flap in the exhaust branch, which constitutes a counternoise source or a so-called “anti-noise” source. The pivoted flap varies the flow cross-section for the exhaust gas and is dynamically driven from the outside. Owing to the movement of the flap, vibrations, more precisely pressure pulsations are produced, depending on the deflection of the flap and the frequency of its movement. These pressure pulsations are superimposed on the motor-side pressure pulsations and therefore eliminate, partially eliminate, or intensify these pressure pulsations. The noise level can thus be purposefully influenced and/or a completely different sound design can be produced. The flap is preferably arranged near a “cold end” of the exhaust system. Both the static and the dynamic opening angle of the flap are controlled depending, e.g., on the motor load and on the number of revolutions of the motor. The previous devices could not yet gain acceptance in practice since the drive motors were comparatively large and heavy in order to obtain a sufficient service life, and to be able to move the flap fast enough. The amount of heat produced by the motor usually increases as its weight increases. All in all, a negative spiral can thus be started so that the reliable continuous operation can be adversely affected.

One proposed solution has included integral cooling rigs in an attempt to reduce the adverse effects of heat. These integrally formed cooling ribs as used in the prior art dissipate the heat to the ambient air but do not provide sufficient cooling.

### SUMMARY OF THE INVENTION

To avoid the aforementioned drawbacks, in a device of the type initially mentioned, the invention provides a driving device that is equipped with at least one active cooling system. In the invention, a fluid is actively supplied (i.e. via pumps, for example) to the driving device for the first time to purposefully cool the driving device. Another important feature resulting therefrom is the extensive thermal decoupling between the drive motor and the closure member in the hot flow. The extremely hot exhaust gases (up to 750° C.) can heat the driving device excessively, which can result in a deterioration of the motor or in a thermally induced oversize of the motor. Furthermore, excessive thermal expansion processes are generated in the force transmission member, which can lead to problems concerning the mounting of the flap and of the motor, and also to problems in the force transmission member.

Due to the cooling system provided according to the invention, the drive motor can be dimensioned to be considerably smaller and lighter, which in turn has a positive effect on the reduction of the inert masses.

As already mentioned, the device according to the invention is in particular provided for the control of the noise emission, i.e. for the sound design. The motor can move the closure member with sufficient speed such that the closure member produces pressure pulsations in the exhaust gas, which lead to an audible sound emission. This means that the motor-side pressure pulsations are eliminated, partially eliminated, intensified, or that inherent pressure pulsations are simply superimposed.

According to one embodiment of the invention, the force transmission member includes a coupling which couples a flow-side drive train to a motor-side drive train. The coupling thus divides the force transmission member into two sections. Owing to the coupling, it is possible to partially compensate for the thermal expansion processes. Furthermore, the coupling can compensate for a positional and/or angular offset of the drive trains. This is particularly important if the force transmission member is a directly driven rotating shaft, i.e. there is no force deflection.

The advantages of the coupling are therefore effective in particular if the rotation axis of the flap is substantially coaxial to the rotation axis of the drive motor.

Alternatively or additionally, the coupling can be configured as a thermal decoupling member that would and make a heat conduction between the drive trains at least more difficult. As already mentioned above, due to the thermal decoupling member, the heat radiated by the exhaust gas is no longer guided to the drive motor. This constitutes an additional possibility of eliminating the thermal problems.

In one example, the coupling includes a thermal decoupling member. With respect to the drive, the thermal decoupling member is force-transmitting and should have a thermal conductivity that is lower than the thermal conductivity of the two drive trains at least by a factor of 3, preferably at least by a factor of 5. This means that the decoupling member is not only that part having the lowest thermal conductivity in the system, but has in fact a considerably lower thermal conductivity than the remaining force transmission member. Preferably, the thermal conductivity is lower than that of metal by a factor of 4.

In order to obtain this thermal decoupling, ceramic materials or mica can be used for the decoupling member.

The cooling system is to be provided at that section of the force transmission member that is located outside of the exhaust gas flow, i.e. not in the exhaust gas carrying pipe such that this pipe is not influenced thermally.

According to one embodiment, the cooling system is provided at the coupling and/or at the drive motor to cool the drive motor. Here, one cooling system or a plurality of separate cooling systems can be employed.

The cooling system in one example has a coolant cycle, in particular a cooling liquid cycle. This cycle should be decoupled from the normal cooling cycle of the vehicle since the latter can get too hot during driving operation.

Alternatively, it is however also possible to supply air, for example, into the cooling system, or to that part that is to be cooled.

A good heat dissipation is obtained if the cooling system has a heat exchanger surrounding the part that is to be cooled.

In the invention, the closure member is usually a rotatable flap, for example a throttle flap.

Further features and advantages of the invention will be apparent from the description below and from the drawings below to which reference is made.

### BRIEF DESCRIPTION OF THE DRAWINGS

FIG. 1 shows a perspective view of a device according to the invention;

FIG. 2 shows an enlarged sectional view of that section of a force transmission member that is equipped with a thermal decoupling member;

FIG. 3 shows a sectional view through a drive motor used in the invention;

FIG. 4 shows a perspective view of a closure member used in the invention, along with a rotating shaft;

FIG. 5 shows a perspective view of a half-shell defining, along with a counter shell, the line section in which a flap is seated;

FIG. 6 shows part of an exhaust branch of a vehicle with the integrated device according to the invention;

FIG. 7 shows a block diagram showing control sequences in the invention;

FIG. 8 shows a perspective view, partially cut open, of a second embodiment of the device according to the invention; and

FIG. 9 shows an enlarged view of the device of FIG. 8 in a region of the rotating shaft connection.

### DETAILED DESCRIPTION OF THE PREFERRED EMBODIMENT

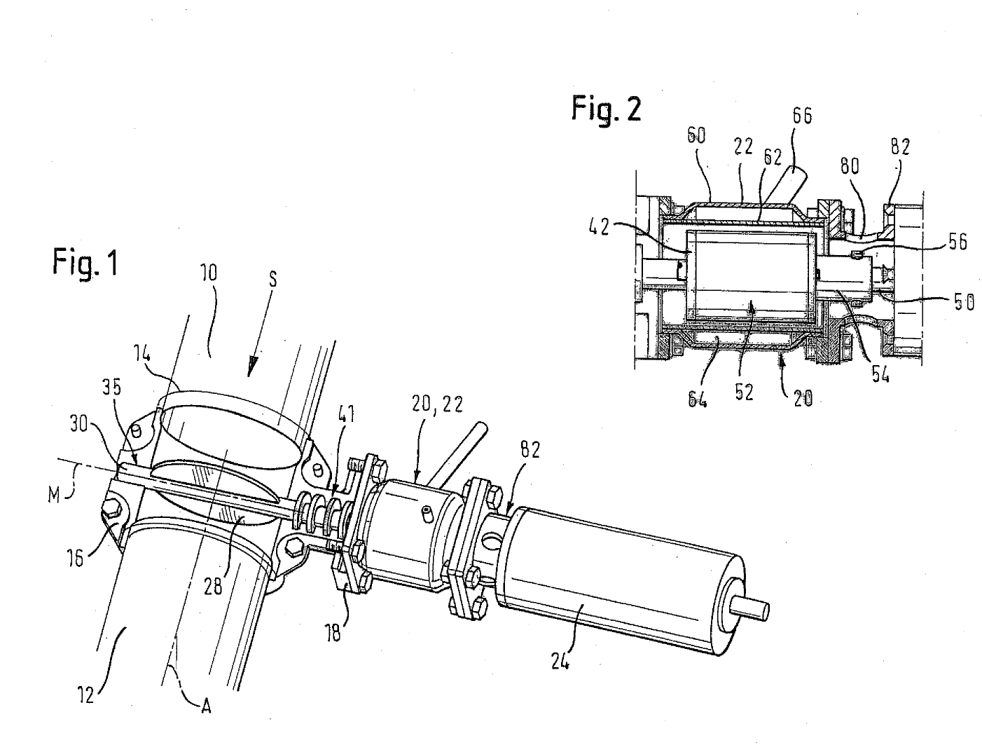

FIG. 1 shows a device for influencing an exhaust gas flow, more precisely a device for controlling the sound emission in an exhaust branch of a combustion engine. An exhaust gas supply pipe 10 supplies hot exhaust gas to the device, and a pipe 12 leads the exhaust gas away from the device towards an outlet. A line section on the side of the device is seated between the pipes 10, 12. This line section is concentric to the pipes 10, 12 and comprises two half-shells 14, 16 that are identical in terms of geometry, form and size.

FIG. 5 illustrates one of the half-shells 14, 16. A fastening flange 18 is integrally formed with the half-shells 14, 16 which are made of ceramic material or metal and are preferably cast. The fastening flange 18 includes two sections which are each associated with one of the half-shells 14, 16.

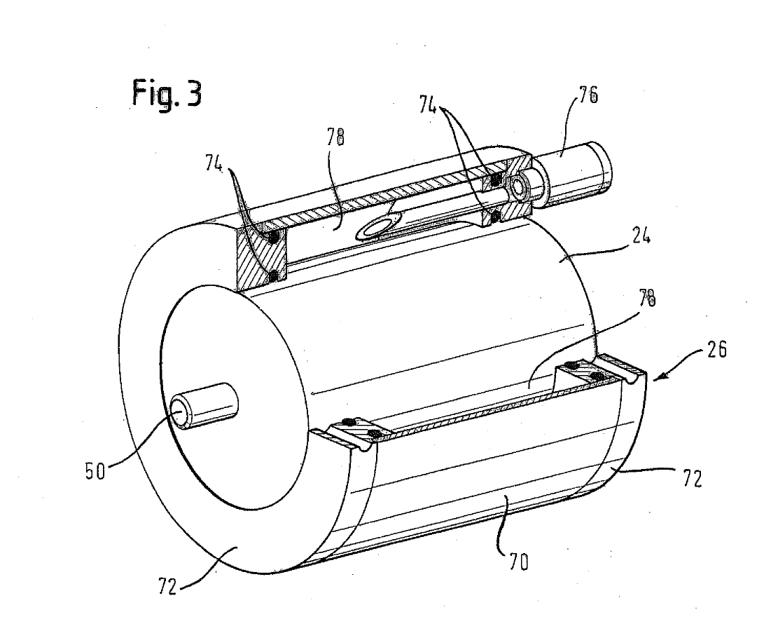

A unit comprised of a coupling 20 and of an active cooling system 22 surrounding the coupling 20 (see FIG. 2) is flanged to the fastening flange 18, and an electric drive motor 24 (see FIG. 3) having an active cooling system 26 is in turn flanged to this unit.

The drive motor 24 serves to set a closure member in motion which has the form of a rotatable throttle flap 28 and is seated in the exhaust gas flow S. More specifically, the drive motor 24 rotates the flap 28 about a center axis M defined by a rotating shaft 30 connected with the flap 28. The rotating shaft 30 is part of the so-called “force transmission” member between the drive motor 24 and the flap 28. This force transmission member constitutes, along with the drive motor 24, the so-called “driving device” for the flap 28.

The details of the different units of the device according to the invention are discussed below.

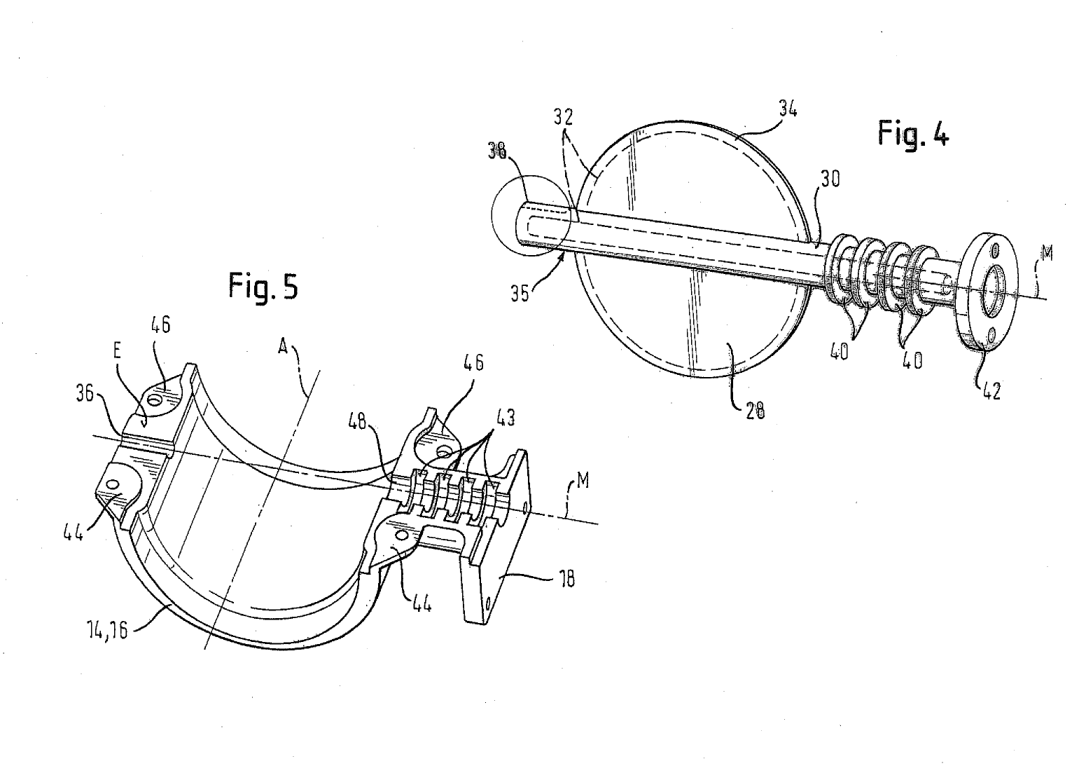

The flap 28 is shown in detail in FIG. 4. The flap 28 itself is a disk-shaped part which can have the profile of an airfoil as viewed in cross-section and perpendicularly to the flow direction. Depending on its angular position, the flap 28 offers different flow resistances to the exhaust gas and varies the flow cross-section in a continuously variable manner.

Due to the high forces acting on the flap 28, the flap 28 is manufactured in one piece along with the rotating shaft 30. The flap 28 and/or the rotating shaft 30 have, for example, a metallic core 32 which is sketched in broken lines and is entirely surrounded by a common ceramic material 34. The metallic core 32 can be comprised of two individual parts which are connected with each other merely by the ceramic material or by a different method before the coating with ceramic material. However, the entire metallic core 32 is preferably also integrally formed, without welding or similar, i.e. formed in one piece.

An alternative embodiment provides that the flap 28 and/or the rotating shaft 30 has a hollow chamber structure, for example a kind of honeycomb structure, to obtain a high stability in combination with a low thermal capacity. It is also possible to provide this hollow chamber structure merely in the inside, for example in the metallic core, with a coating of ceramic material or glass then ensuring a smooth and hard outer surface.

A different type of manufacturing for the rotating shaft 30 and the flap 28 is realized, for example, in that both parts are produced separately and then entirely coated with glass, the glass connecting the two parts with each other.

It is however also possible to manufacture the flap 28 and the rotating shaft 30 completely, i.e. only of ceramic material. Ceramic material ensures a low heat conduction and slight heat expansion processes.

With regard to FIG. 4, the rotating shaft 30 slightly projects with respect to the flap 28 and forms in this region a bearing stub 35 that is seated in an appropriate recess (bearing bore 36) in the half-shells 14, 16.

In the region of the bearing stub 35, the rotating shaft 30 can be coated, for example, with silicon nitride or with a different ceramic material, in particular using the so-called “plasma coating” method. Alternatively, it would be possible to provide the rotating shaft 30 with a bearing ring in the region of the bearing stub 35. The bearing ring is connected with the rotating shaft 30 by glazing, with the bearing stub being coated with liquid glass first, and then the bearing ring being subsequently placed thereon before the parts are heated to harden the glass. In FIG. 4, the ceramic coating or the bearing ring is illustrated merely symbolically and provided with reference number 38.

On the side opposite to the bearing stub 35, the rotating shaft 30 also projects laterally with respect to the flap 28. Outside of the exhaust gas flow S, this drive-side section has disk-shaped, radial projections 40 that are integrally formed therewith and constitute part of a labyrinth seal 41. A fastening flange 42 is also integrally formed at the free end. The projections 40 and the flange 42 are preferably also made of ceramic material.

A manufacturing method, not yet discussed above, for the flap 28 and the rotating shaft 30, and if appropriate along with the projections 40 and the flange 42, is the so-called “ceramic injection molding” method (CIM method).

The half-shells 14, 16 have recesses 43 that are complementary to the projections 40 and in which the projections 40 are received.

FIG. 5 shows one of the half-shells 14, 16 in more detail. As already mentioned, the half-shells 14, 16 are identical. Their parting plane E extends through the center axis M of the rotating shaft 30 and through a longitudinal axis A of the line section which is formed by the half-shells 14, 16, but which runs coaxially to the longitudinal axis of the adjacent pipes 10, 12. Starting from the parting plane E, some contoured sections project upwards to form projections 44. On the opposed side with respect to the axis M, the half-shells 14, 16 have recesses 46 that are complementary to the projections 44. When one half-shell is placed onto the other, the projections 44 project into the recesses 46 so that a precise interlocking fit is obtained.

The bore 36 for the bearing stub 35 and an opposed recess (bore 48), which has a larger diameter, are produced using a so-called “step drill” which, with respect to FIG. 5, is driven into the half-shells 14, 16 from the right when the half-shells 14, 16 are connected with each other.

While the rotating shaft 30 has always been discussed with respect to the flap 28 in the foregoing, it should be understood that the rotating shaft 30 extends up to a drive shaft 50 of the drive motor 24 inclusive (see FIG. 3) and is comprised of a plurality of sections/individual parts. One of these sections is the shaft section 30 that is directly connected with the flap 28.

The flap 28, along with the rotating shaft 30, is inserted into a lower shell 16 for mounting, and the upper shell 14 is placed thereon. Afterwards, the shells 14, 16 can be fastened to each other (see FIG. 1).

The flange 42 is part of a coupling 20 shown in FIG. 2, which serves both as a thermal decoupling member and as a compensating member to compensate for the positional and/or angular offset of a flow-side and motor-side drive trains (more specifically of the sections of the rotating shaft).

The coupling 20 comprises a thermal decoupling member 52, in one example which is mounted directly to the flange 42 in a mechanical manner or by bonding, for example. On the drive side, the decoupling member 52 is also connected with a flange part 54, which is connected with the drive shaft 50 of the drive motor 24 directly or via an intermediate shaft. A screw 56, laterally driven through a sleeve section of the flange port 54, is used to couple the coupling 20 to the drive shaft 50 or the intermediate shaft.

The thermal decoupling member 52 is intended to make the heat conduction between the drive trains at least more difficult. To this end, the thermal decoupling member 52 has a thermal conductivity which is lower than the overall thermal conductivity of the two drive trains adjoining the decoupling member 52 at least by a factor of 3, and preferably by a factor of 5. The thermal conductivity is lower than that of a metal at least by a factor of 4. To obtain this result, the decoupling member 52 is made of ceramic material or mica, for example, and in particular is configured as a one-piece component. In the region of the coupling 20, the two drive trains have a small radial play for a radial tolerance compensation between the drive trains.

In addition, at least sections of the flow-side drive train are also axially provided with a play, in particular the rotating shaft 30 in the half-shells 14, 16. This axial play is to prevent the parts from jamming due to thermal expansion processes.

The entire bearing of the flap 28 and of the force transmission member occurs at a maximum of three points. The bearing stub 35 is part of a movable bearing, whereas the connection of the drive shaft 50 with the drive motor 24 constitutes a fixed bearing. Furthermore, a radial support can also be provided in the region of the bore 48.

As can be seen in FIG. 2, the decoupling member 52 has to transmit the entire drive power, i.e. the entire torque. There is no other mechanical bridge which could then possibly act as a heat conducting bridge.

The entire driving device is fastened to the half-shells 14, 16 and therefore to the exhaust pipe so that the entire device forms a self-contained unit.

The coupling 20 is surrounded by a multi-shell housing which, as already mentioned, is directly screwed to the flange 18, and to which the entire drive unit is screwed at the opposed end. The housing has an outer shell 60 and an inner shell 62 that define a ring chamber 64 between each other and form a heat exchanger as part of an active cooling system for the coupling 20. A hose pipe system 66 supplies cooling fluid, in particular water or compressed air, into the ring chamber 64 and thus dissipates heat in the region of the coupling 20. The cooling system 22 and the thermal decoupling member 52 prevent a heat conduction resulting from a strongly heated flow-side drive train during driving operation.

The drive motor 24 itself is also equipped with an appropriate active cooling system 26 that is illustrated in FIG. 3. Here, an outer wall 70 is connected with two end walls 72, which in turn are in direct sealing contact with an outer envelope of the drive motor 24. Reference number 74 denotes appropriate O-rings. Cooling fluid, for example compressed air or water, is supplied into a ring chamber 78 via a connector 76, which results in an intensive cooling of the drive motor 24. An appropriate outlet connector is also present but not illustrated in the figures. The outer envelope of the drive motor 24, which is illustrated in FIG. 3, constitutes a heat exchanger for dissipating the heat present in the drive motor.

The two cooling systems 22, 26 can be operated jointly or in a state in which they are decoupled from each other. A drive pump for the cooling fluid is present but not illustrated.

During driving operation, a high gas pressure prevails in the exhaust branch so that a small amount of gas can flow in the actually tight space between the housing of the coupling 20 and the coupling itself via the labyrinth seal 41. This gas pulsates and could lead to an undesired loading, expansion, or oscillating of the housing of the coupling 20. For this reason, an outlet opening 80 leading to the open air is intentionally provided in an optional intermediate flange part 82 between the housing and the drive motor 24 (see FIG. 2). The screw 56 can also be fastened via this opening 80.

The device according to the invention is mounted in the exhaust branch between a front muffler or an exhaust gas aftertreatment unit, and a rear muffler, end muffler, or the end pipe.

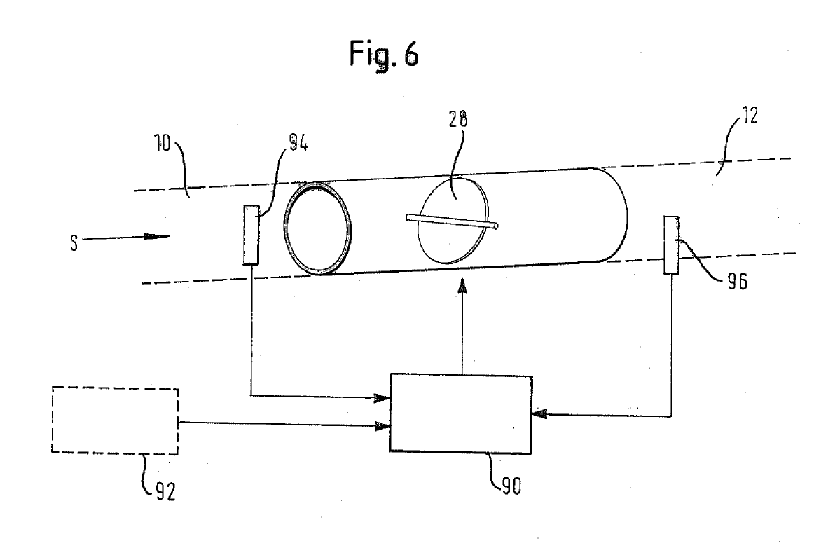

As can be seen in FIG. 6, the drive motor 24 is coupled to a control device 90 receiving data from a combustion engine 92, from a back pressure sensor 94 preferably arranged upstream of the front muffler, and from a sensor 96 for dynamic pressure (ram pressure) arranged downstream of the device and upstream of the rear muffler.

By way of the continuously adjustable angular position and angular velocity of the flap 28, the device controls the back pressure in the exhaust system since the static back pressure depends on the flow cross-section, and, if necessary, thus eliminates more or less strong pulsations in the exhaust gas, or generates its own sound spectrum.

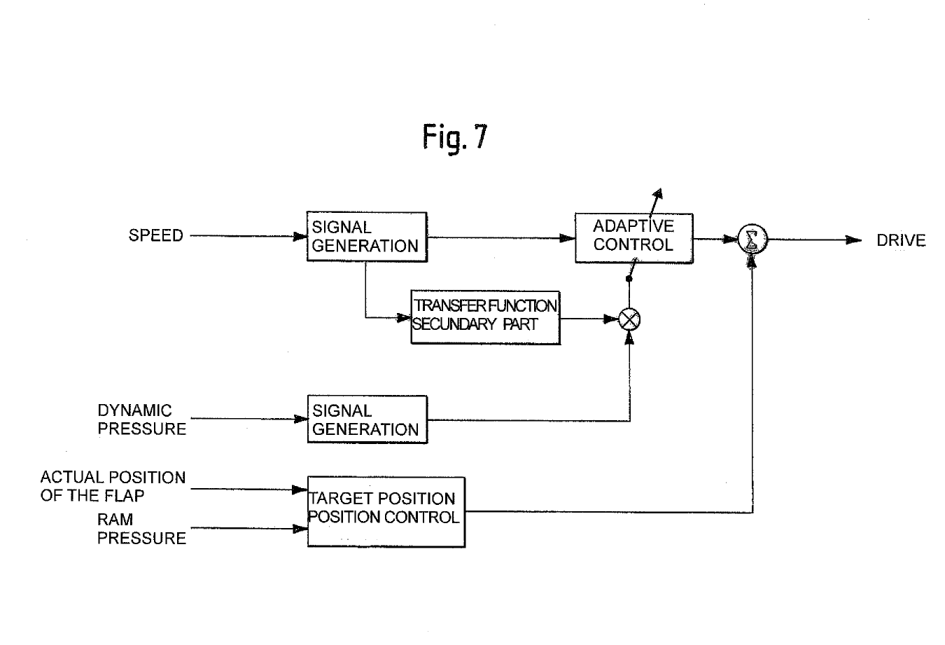

The dynamic control of the flap 28 (see FIG. 7) as provided takes place depending on the revolutions of the motor 24 and other parameters, for example the electric control signal which the amount of fuel injected into the engine is also controlled, or depending on the signal of the pressure pulsations downstream of the flap 28. The back pressure sensor 94 upstream of the flap 28 measures the actual back pressure.

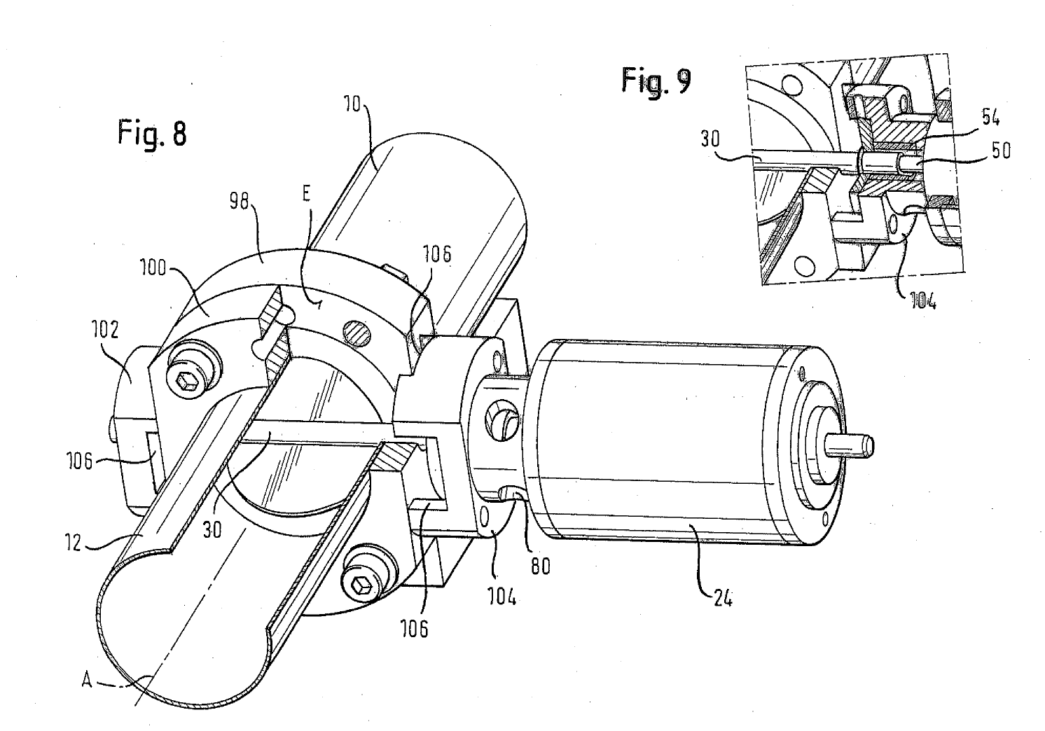

In the second embodiment illustrated in FIG. 8, the flap is not received in the half-shells 14, 16 but in flanges 98, 100 which are associated with the pipes 10, 12 and fastened thereto, for example by casting the pipes 10, 12 along with the flanges 98, 100 associated therewith. Consequently, the parting plane E between these two parts extends vertically, i.e. perpendicularly to the pipe axis A, rather than horizontally, i.e. in a plane comprising the pipe axis A.

However, in an identical manner to the half-shells 14, 16, each flange 98, 100 has one half of the bearing points or of the passages for the rotating shaft 30. This embodiment distinguishes itself by a simpler manufacturability in comparison with the half-shells.

The flanges 98, 100 can contain the bearings for the rotating shaft 30 and for the drive motor 24 and can have appropriate bores. Alternatively, it is however also possible to mount separate bearing parts 102, 104 to the flanges 98, 100, which are manufactured separately and constitute the bearings of the rotating shaft 30 and the support for the drive motor 24.

To further improve cooling, the bearing parts 102, 104 have recesses 106 such as, e.g., milled recesses, in the region of transition to the flanges 98, 100 that get hot during operation. Via these recesses 106, hot gases which escape via the bores in the flanges 98, 100 can also be discharged. The hot gases are thus prevented from striking the heat sensitive elements such as the motor and the bearings.

FIG. 9 shows the bearing part 104 in a cut view. It can be seen that the rotating shaft 30 can be mounted in the flanges 98, 100, which, however, is not obligatory. The rotating shaft 30 is directly coupled to the drive shaft 50 via a flange part 54. Alternatively, it is also possible to provide the coupling 20.

Additionally, a coolant can be introduced into the inside of the bearing part 104 via the outlet opening 80, for example, which, however, is not obligatory.

The remaining details from the embodiment according to the preceding figures, for example the labyrinth seal etc., can also be realized in the embodiment according to FIGS. 8 and 9.

After having inserted the flap 28 and the rotating shaft 30, the flanges 98, 100 are simply fastened together. The bearing parts 102, 104 are then screwed to the resulting unit consisting of the two flanges 98, 100.

It is possible to realize an open loop and also a closed loop control of the device according to the invention.

The drive motor is preferably a brushless motor having an encoder. Operation with a CAN-bus system is also possible. To prevent the generation of harmonic oscillations in the motor motion, a drive motor with linear transmission is preferably chosen.

In addition, the power amplifier of the motor is also important, a so-called “sinus commutation” being in particular chosen in this connection.

Finally, to be able to obtain a high motor output, permanently excited motors having stationary stator windings are, for example, used which directly adjoin the motor housing.

In one example, the device is operated at frequency ranges of between 30 and 300 Hz so that the passive sound reduction via mufflers is required only in the range of 300 to approximately 1000 Hz. This allows a general reduction of the muffler volume.

The dynamic control of the system must ensure a noise damping of up to approximately ten acoustic engine orders (half and complete orders) in a revolution range of 800 to about 6000 revolutions per minute in the case of normal road vehicles, and even higher speeds in the case of sports cars and motorcycles. Input signals for the adaptive control are generated on the basis of the current engine speed. These signals are additionally filtered, more specifically employing a transfer function, and are then used along with the processed pressure signals to adapt the control.

It has to be pointed out that the specific features mentioned in detail such as, e.g., the thermal decoupling, the radial play in parts of the drive train, the coupling, the labyrinth seal, the cooling system and the configuration of the appropriate housings, the half-shells 14, 16, the flanges 98, 100, the specific designs of the flap 28 and of the rotating shaft 30 and their manufacturing methods, of their structure, of their bearing and their bearing production, form, each separately and independently of an independent claim, separate patentable subject matters.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A device for influencing an exhaust gas flow, in particular for controlling sound emission in an exhaust branch of an engine, comprising:
a closure member movably arranged in an exhaust gas flow; and
a driving device for the closure member, the driving device including a drive motor and a force transmission member to couple the drive motor to the closure member for drive, the closure member offering different flow resistances to the exhaust gas flow depending on a position of the closure member in the exhaust gas flow, and wherein the driving device is equipped with at least one active cooling system.

2. The device according to claim 1, wherein the motor moves the closure member with sufficient speed to generate pressure pulsations in the exhaust gas which lead to an audible sound emission.

3. The device according to claim 1, wherein the force transmission member includes a coupling which couples a flow-side drive train to a motor-side drive train.

4. The device according to claim 3, wherein the coupling compensates for a positional and/or an angular offset of the flow-side and motor-side drive trains.

5. The device according to claim 3, wherein the coupling is configured as a thermal decoupling member to reduce a heat conduction between the flow-side and motor side drive trains.

6. The device according to claim 5, wherein the coupling includes a force-transmitting, thermal decoupling member having a thermal conductivity that is lower than an overall thermal conductivity of the flow-side and motor-side drive trains at least by a factor of 3.

7. The device according to claim 5, wherein the thermal decoupling member is made of ceramic material or of mica.

8. The device according to claim 3, wherein the at least one active cooling system is provided at a section of the force transmission member that is located outside of the exhaust gas flow.

9. The device according to claim 3, wherein the at last one active cooling system is provided at the coupling.

10. The device according to claim 1, wherein the at least one active cooling system is provided at the drive motor and cools the drive motor.

11. The device according to claim 1, wherein the at least one active cooling system includes a coolant cycle.

12. The device according to claim 1, wherein the at least one active cooling system includes a liquid cycle.

13. The device according to claim 1, wherein the at least one active cooling system has a heat exchanger surrounding a part that is to be cooled.

14. The device according to claim 1, wherein the closure member is a rotatable flap.

15. The device according to claim 1, wherein the force transmission member is a directly driven rotating shaft.

16. The device according to claim 14, wherein a rotation axis of the rotatable flap is substantially coaxial to a drive shaft of the drive motor.

17. The device according to claim 5, wherein the coupling includes a force-transmitting, thermal decoupling member having a thermal conductivity that is lower than an overall thermal conductivity of the flow-side and motor-side drive trains at least by a factor of 5.
